(19) United States
(12) Patent Application Publication
(10) Pub. No.: US 2008/0049765 A1
(43) Pub. Date: Feb. 28, 2008

(54) Method and system for inter working a point-to-point link and a LAN service

(75) Inventor: Jonathan Sadler, Naperville, IL (US)

Correspondence Address: THE SMALL PATENT LAW GROUP LLP, 611 OLIVE STREET, SUITE1611, ST. LOUIS, MO, 63101, US

(73) Assignee: TELLABS OPERATIONS, INC.

(21) Appl. No.: 11/509,345

(22) Filed: Aug. 24, 2006

(51) Int. Cl. H04L 12/56

(52) U.S. Cl. 370/401

(57) ABSTRACT

An interworking device is provided that affords an interface between a point-to-point (P2P) environment and a local access network (LAN) environment. The interworking device comprises a P2P frame transceiver adapted to communicate with a P2P host utilizing P2P frames formatted in accordance with a P2P protocol. A LAN frame transceiver is adapted to communicate, over a LAN environment, with a LAN host utilizing LAN frames formatted in accordance with a LAN protocol. The P2P and LAN frames include client traffic having client level network layer (NL) information associated with a common predefined client level network layer protocol. A data forwarding module utilizes the NL information to map the client traffic from at least one of i) the P2P frames into the LAN environment and ii) the LAN frames into the P2P environment.

### BACKGROUND OF THE INVENTION

The present invention relates generally to interworking functions between different networks, and more particularly to methods and systems for interworking a point-to-point network and a local access network service.

Different network technologies are used today in various applications and are distributed between diverse geographic sites. In certain applications, a company may utilize one type of network technology in a local area network (LAN) service (e.g., Ethernet), and may utilize a different type of network technology at other sites that are remote from the local access network. By way of example, the company may provide an Ethernet service within the main office, but separately connect remote network equipment through routers that maintain point-to-point (P2P) links with the main office. The P2P links may be supported by a Digital Subscriber Loop (DSL) connection or leased lines such as T1 facilities to a router at the main office. A large number of P2P facilities have been deployed over the past years around the world. For example, banks install P2P links between each automated teller machine (ATM) and regional offices of the bank.

Today, in many industries, there is a substantial push to use LAN technologies such as Ethernet between geographically diverse sites within a company. In general, service providers are also interested in providing better integration between remote sites and LAN services. To achieve total integration, one would need to provide a LAN (e.g. Ethernet) device at the remote site in order to directly join the remote site to the company's LAN service. However, providing LAN service out to a remote premise requires a large change in equipment and introduces substantial cost. For example, continuing the banking example, to provide Ethernet-based service at each ATM, the company would need to change the equipment at each ATM and change the line leading back to the company's network. The costs may outweigh the benefit.

Therefore, a need exists to utilize existing P2P facilities at remote sites and connect the P2P facilities to a LAN service.

Today, many of the P2P access methods (e.g. DSL networks) use the Point-to-Point Protocol (PPP) documented in IETF RFC 1661 to establish links between geographically distributed hosts and the backbone network. In certain applications, each host encapsulates network layer (NL) packets (e.g. Internet Protocol (IP)) within a PPP formatted frame for delivery to a remote service network at another PPP host. By way of example, the PPP hosts may establish a PPP session by tunneling across a regional aggregation network using a Layer 2 Tunneling Protocol (L2TP) for delivery to a service network. The service network at one or both ends of the PPP session is typically maintained by a different service provider than the service provider maintaining all or a portion of the regional aggregate network through which the PPP session is established.

However, systems have experienced difficulty in establishing and maintaining PPP sessions tunneled across regional aggregate networks, such as in maintaining a required quality of service and the like. To address quality of service concerns, the DSL Forum has completed a new architecture (as outlined in DSL forum TR-59) that requires regional aggregate networks to participate in the service networks IP routing environment. Conventional L2TP architectures did not require the regional aggregate network to participate in the service networks IP routing environment. The additional requirement of participation by the regional aggregate network introduces unnecessary operational complexity in the regional network as well as requiring service networks to turn over, to the regional aggregate network, IP layer management for access links (including management of address assignment and network structure).

Therefore, a need exists for improved methods and systems to interface P2P and LAN services.

### BRIEF DESCRIPTION OF THE INVENTION

In accordance with one exemplary embodiment, an interworking device is provided that affords an interface between a point-to-point (P2P) environment and a local access network (LAN) environment. The interworking device comprises a P2P frame transceiver adapted to communicate with an attached device utilizing frames formatted in accordance with a P2P protocol such as PPP. A LAN frame transceiver is adapted to communicate, over a LAN environment, with LAN attached devices utilizing LAN frames formatted in accordance with a LAN protocol. The P2P and LAN frames include network layer (NL) information associated with a common predefined network layer protocol. A data forwarding module utilizes the NL information to map the client traffic from i) the P2P frames into the LAN environment and ii) the LAN frames into the P2P environment.

Optionally, the NL information may include NL addresses. The P2P and LAN frames may include at least one of automatic network layer address assignment information, fault handling information, P2P node identification information, local LAN traffic destination information and remote LAN traffic destination information. The device may further include a P2P-to-network layer (P2P/NL) Address Assignment function that determines when the P2P frame includes a control protocol to request a network layer address. An example of such a protocol used with IP and PPP is Internet Protocol Control Protocol (IPCP).

Optionally, the device may further comprise memory storing a table assisting the mapping of P2P endpoints into LAN addresses (e.g. MAC addresses). This assist table would contain a LAN address and an NL address associated with a host on the P2P environment. The data forwarding module utilizes the LAN and NL addresses to convey the NL traffic to and from the LAN environment. A NL address analysis function may be provided that determines whether an NL address in the client traffic corresponds to a local LAN. Further, a control module may be included that assigns a LAN address to a physical link between the P2P interface and a host in the P2P environment.

In accordance with an alternative exemplary embodiment, a method is provided for interfacing between a point-to-point (P2P) environment and a local area access network environment. The method includes communicating with a P2P host utilizing P2P frames formatted in accordance with a P2P protocol and communicating, over a LAN environment, with a LAN host utilizing LAN frames formatted in accordance with a LAN protocol. The P2P and LAN frames include client traffic having network layer information associated with a common predefined client level network layer protocol. The method further includes utilizing the NL information to map the client traffic from at least one of i) the P2P frames into the LAN environment and ii) the LAN frames into the P2P environment.

Optionally, the method may further comprise obtaining, from a LAN network layer address assignment server (e.g. a Dynamic Host Configuration Protocol (DHCP) server for LANs supporting an IP network layer) on the LAN environment, an NL address to be allocated for the P2P host. A P2P address request (e.g. as conveyed by IPCP in PPP when supporting an IP network layer) from the P2P host is received and, in response thereto, the method includes transmitting an NL address request over the LAN environment.

### BRIEF DESCRIPTION OF THE DRAWINGS

FIG. 1 illustrates a block diagram of a network implementing methods and systems in accordance with exemplary embodiments of the present invention.

FIG. 2 illustrates a block diagram of the modules, tables and functions within the interworking device in accordance with an exemplary embodiment of the present invention.

FIG. 3 illustrates a block diagram of the control module and PPP and LAN frame transceivers in accordance with an exemplary embodiment of the present invention.

FIG. 4 illustrates a flow sequence of the operations carried out to establish a physical link between a P2P host and the interworking device in accordance with an exemplary embodiment of the present invention.

FIG. 5 illustrates a block diagram of the portion of the interworking device utilized to forward data from the P2P environment to the LAN environment in accordance with an exemplary embodiment of the present invention.

FIGS. 6a and 6b illustrate the flow sequence performed in connection with forwarding client traffic from the P2P environment to the local LAN service in the LAN environment in accordance with an exemplary embodiment of the present invention.

FIGS. 7a and 7b illustrate the flow sequence performed when forwarding client traffic from the P2P environment to a remote LAN service in accordance with an exemplary embodiment of the present invention.

FIG. 8 illustrates a flow sequence in connection with the conveyance of client traffic from the LAN host to the P2P host in accordance with exemplary embodiment of the present invention.

FIG. 9 illustrates a flow sequence carried out to shutdown a network layer in accordance with an exemplary embodiment of the present invention.

FIG. 10 illustrates a flow sequence carried out to shutdown all communications across the P2P link in accordance with an exemplary embodiment of the present invention.

### DETAILED DESCRIPTION OF THE INVENTION

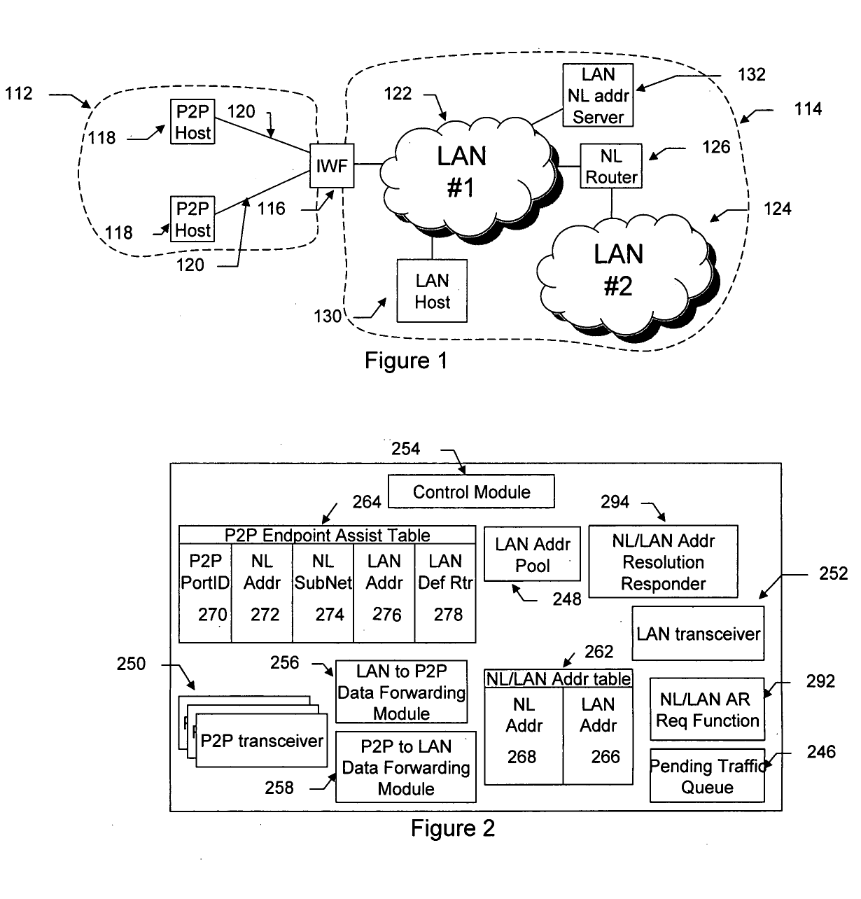

FIG. 1 illustrates a block diagram of a network implementing certain methods and systems in accordance with exemplary embodiments of the present invention. The network is generally apportioned into a point-to-point (P2P) environment 112 and a local access network (LAN) environment 114 that interface with one another through an interworking device 116. The P2P environment 112 includes one or more P2P hosts 118 that are separately joined to the interworking device 116 by individual dedicated links 120. The LAN environment 114 includes one or more LAN services 122 and 124 that are joined to one another through a router 126. The LAN service 122 represents a local LAN service as the interworking device 116 is provided directly connected to the LAN service 122. The LAN service 124 represents a remote service in that the interworking device 116 is not directly connected to the LAN service 124, but instead must communicate through router 126. The local LAN service 122 includes the interworking device 116, one or more LAN hosts 130, a LAN Network Layer Address Server 132 and optionally the router 126. Optionally, the LAN Network Layer Address Server 132 can be placed anywhere in the network, including incorporation into the interworking device 116 or on a network behind router 126. When arranged in this way, router 126 will provide a proxy function that allows the LAN Network Layer Address Server 132 to be reached as if it were directly connected to LAN service 122.

The interworking device 116 provides an interface between the P2P environment 112 and the LAN environment 114. The P2P protocol of the P2P environment 112 represents one layer 2 (or server layer or data link layer of the Open Systems Interconnection (OSI) seven-layer model) protocol, while the LAN protocol of the LAN environment 114 represents another layer 2 protocol. Common examples of P2P and LAN protocols are the Point-to-Point Protocol (PPP) defined in IETF RFC 1661 and Ethernet defined in IEEE 802.3. The P2P and LAN hosts 118 and 130 separately encapsulate client traffic within the layer 2 P2P and LAN frames, respectively. The client traffic includes data packets formatted in accordance with a layer 3 (or client layer or network layer of the OSI seven-layer model) protocol, such as Internet Protocol (IP). The interworking device 116 can provide a seamless client level interface between the respective P2P and LAN environments 112 and 114 utilizing the corresponding layer 2 protocols. The interworking device 116 can be adapted to perform at least one of the functions of disassembling, analyzing and rebuilding the PPP and LAN frames based on the content of the client level traffic.

The interworking device 116 can be adapted to support control operations for establishing and terminating links within the P2P environment 112 and within the LAN environment 114. The interworking device 116 can be adapted to maintain the links while forwarding client traffic from LAN hosts 130 and client-layer routers 126 that attach the local LAN service 122 to the P2P hosts 118, and forwarding data from the P2P hosts 118 to the LAN hosts 130 attached to the local LAN service 122 or to the client-layer router 126, thereby facilitating access to remote LAN service 124. In the present example, the interworking device 116 communicates with the P2P environment 112 based on the PPP protocol, and communicates with the LAN environment 114 based on the Ethernet protocol.

As explained below in more detail, the P2P host 118 and interworking device 116 can be adapted to encapsulate client traffic that includes control and data packets formatted in accordance with the client-level network layer (NL) protocol, within P2P frames for conveyance within P2P environment 112. The interworking device 116 can also be adapted to operate with the LAN environment 114 to encapsulate the client traffic within LAN frames for conveyance within the LAN environment 114. Furthermore, the interworking device 116 can also be adapted to map the client control and data packets between P2P and LAN frame structures in order to afford a seamless interface between the P2P environment 112 and the LAN environment 114.

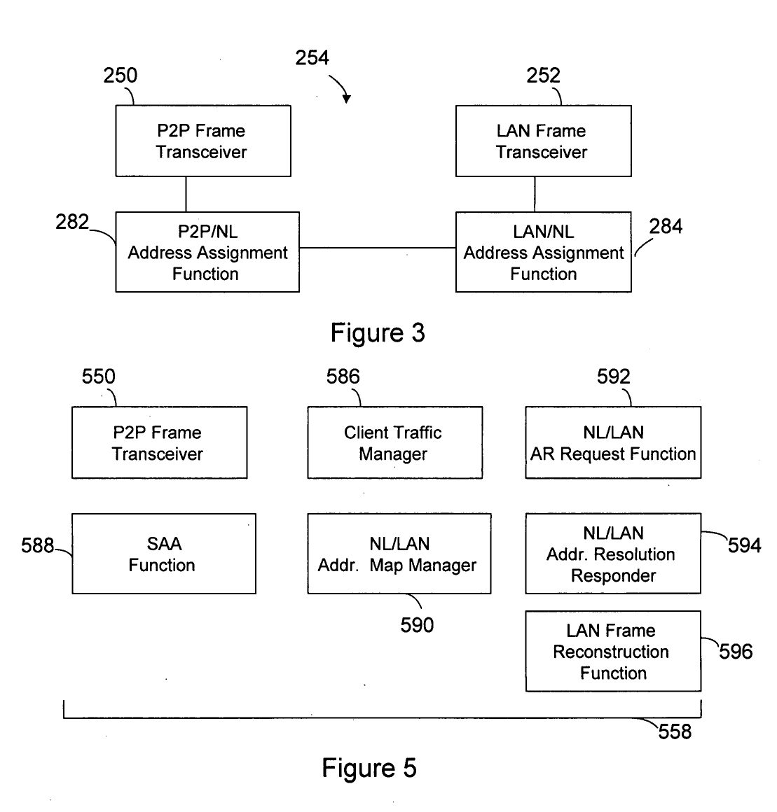

FIG. 2 illustrates a block diagram of the modules, tables and functional blocks within an interworking device (such as interworking device 116 of FIG. 1), in accordance with an exemplary embodiment of the present invention. The interworking device includes a P2P frame transceiver 250 that is joined to links (such as links 120 of FIG. 1), to send/receive P2P frames to/from P2P hosts (such as the P2P hosts 118 of FIG. 1) formatted in accordance with the applicable P2P protocol. The P2P protocol represents an encapsulation protocol that is used to transport client traffic, defined in accordance with a client-layer protocol, over point-to-point serial links. By way of example, the client traffic may be encapsulated utilizing the IETF's Point-to-Point Protocol (PPP). To establish communication over a PPP link (which may be implemented at link 120 of FIG. 1), the P2P host first sends Link Control Protocol (LCP) frames to establish communications across the PPP link. Once the PPP link is established, the P2P host sends Network Control Protocol (NCP) frames to choose and configure one or more client-level network layer protocols. By way of example, the Internet Protocol Control Protocol is the NCP for use with IP client traffic. Once the chosen client-level network layer protocols have been configured, packets from each client-level network layer may be sent over the PPP link. The PPP link will remain configured for communications until LCP or NCP frames close the PPP link or until some external event occurs such as, but not limited to, the failure of the P2P host, the PPP link, or the interworking function.

The interworking device can also include a LAN frame transceiver 252 that is adapted to communicate, over a LAN environment (such as the LAN environment 114 of FIG. 1), with various nodes, including at least one of a LAN host (such as the LAN host 130 of FIG. 1), a router (such as the router 126 of FIG. 1), a LAN Network Layer Address Assignment server (such as the LAN Network Layer Address Assignment server 132 of FIG. 1) and other interconnecting media. Each of the LAN host, router, LAN/NL Address Assignment server and interworking device have a unique LAN address. By way of example, the LAN protocol in use may be Ethernet, which uses Media Access Control (MAC) address for LAN addresses. Furthermore, when the client traffic carried across the LAN environment is IP traffic the LAN Network Layer Address Assignment server may be a Dynamic Host Configuration Protocol (DHCP) server. While not shown, it is understood that other types of nodes may be joined to a LAN service (such as the LAN service 122 of FIG. 1), such as Data Terminal Equipment (DTE) that represent sources or destinations of data frames and Data Communication Equipment (DCE) that represent intermediate network devices that receive and forward frames across the LAN service. By way of example, the DTE may represent PCs, workstations, file servers, print servers and the like, while the DCE may represent repeaters, network switches, routers, interface cards, modems and the like.

A control module 254 manages and conducts the control operations for establishing, maintaining and terminating links within a P2P environment (such as the P2P environment 112 of FIG. 1) and within a LAN environment (such as the LAN environment 114 of FIG. 1) based on client-level NL information that is defined in accordance with a common predefined client-level network layer protocol. The predefined client-level network layer protocol extends across both of the P2P and LAN environments. The NL information may include, among other things, source and destination Network Layer addresses (such as IP addresses), address assignment information, fault handling information, P2P node identification information, local LAN traffic destination information and remote LAN traffic destination information.

FIG. 2 illustrates separate modules for exemplary data forwarding operations. Data forwarding module 256 supports conveyance of client traffic from the LAN environment 114 to the P2P environment 112. Data forwarding module 258 supports conveyance of client traffic from the P2P environment to a local LAN service (such as the LAN service 122 of FIG. 1) and to a remote LAN service (such as the LAN service 124 of FIG. 1).

The interworking device can also include a Network Layer address to LAN address table 262 and furthermore a P2P endpoint assist (P2P/NL/MAC) table 264. The Network Layer address to LAN address table 262 can include a LAN address field 266 and a Network Layer address field 268 that store LAN and Network Layer addresses in a one-to-one relation with one another. The P2P Endpoint Assist table 264 can include a P2P link physical port field 270, a P2P host NL address field 272, an NL subnet field 274, a LAN address field 276, and a LAN Default Router field 278 that store corresponding information also in a one to one relation to one another. The fields 266-278, Network Layer address to LAN address table 262 and P2P Endpoint Assist table 264 are described below in more detail. The control module 254 can communicates with P2P hosts (such as the P2P hosts 118 of FIG. 1), LAN hosts (such as the LAN hosts 130 of FIG. 1), a router (such as the router 126 of FIG. 1) and a DHCP server (such as the DHCP server 132 of FIG. 1) in order to build and maintain the Network Layer address to LAN address and P2P Endpoint Assist tables 262 and 264. The data forwarding modules 256 and 258 access and update the Network Layer address to LAN address and P2P Endpoint Assist tables 262 and 264 in order to map client traffic packets between the P2P and LAN environments. The interworking device can also maintain a LAN address pool 248 and a pending traffic queue 246.

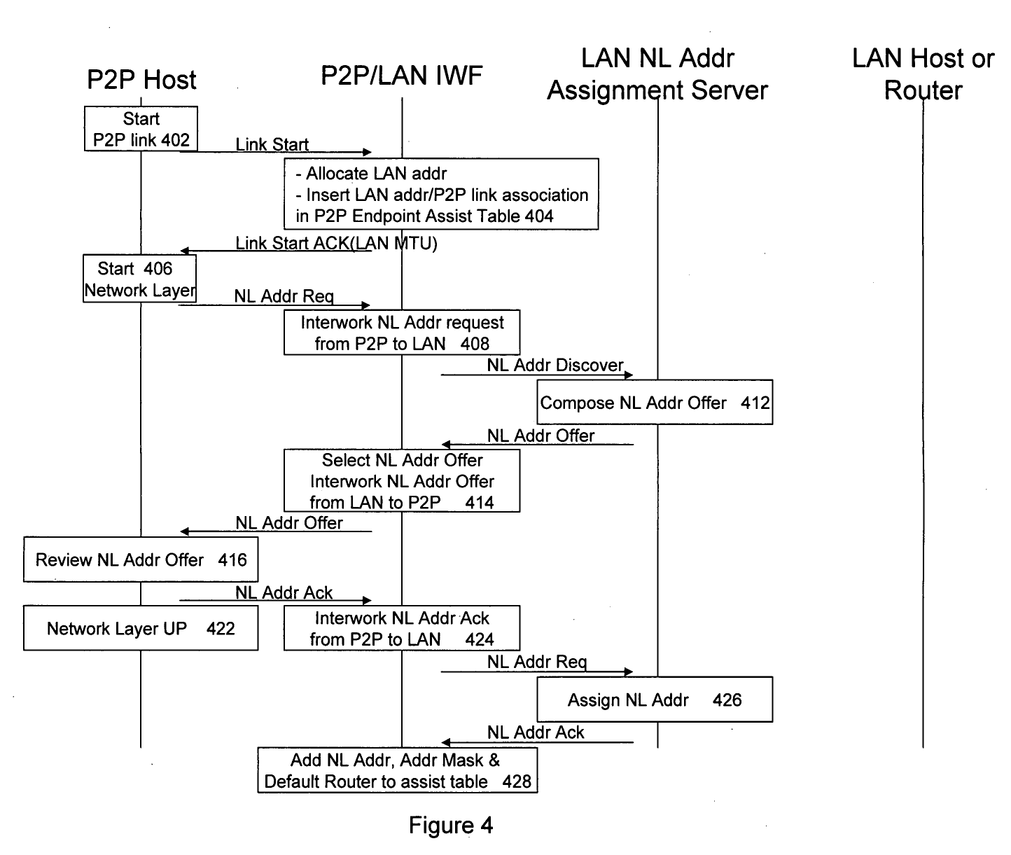

FIG. 3 illustrates a block diagram of a control module (such as control module 254 of FIG. 2) and P2P and LAN frame transceivers (such as the P2P and LAN frame transceivers 250 and 252 of FIG. 2), in accordance with an exemplary embodiment of the present invention. The P2P frame transceiver 250, during reception, receives the P2P frames and extracts NL information from the P2P frames. The P2P frame transceiver 250, during transmission, loads client traffic and NL information into a P2P frame and sends the P2P frame over the corresponding link. During reception, the LAN frame transceiver 252 receives LAN frames and extracts client traffic and NL information therefrom. During transmission, the LAN frame transceiver 252 loads client traffic and NL information into a LAN frame and sends the LAN frame over the LAN service 222 to the DTE or DCE with corresponding MAC address. The control module (such as control module 254 of FIG. 2) includes a P2P/NL Address Assignment function 282 that communicates with a P2P host (such as each of the P2P hosts 118 of FIG. 1) in accordance with an applicable P2P Protocol to coordinate configuration of Network Layer addresses on the P2P host. By way of example, the IP Control Protocol (IPCP) is used to receive and process requests for unique IP addresses from P2P hosts using the P2P protocol. The control module (such as control module 254 of FIG. 2) also includes a LAN/NL Address Assignment function 284. The P2P/NL Address Assignment function 282 communicates with the LAN/NL Address Assignment function 284 that in turn communicates with a LAN/NL Address assignment server (such as the LAN/NL Address assignment server 132 of FIG. 1) to obtain a Network Layer address to be allocated to the requesting P2P host. By way of example, the Dynamic Host Configuration Protocol (DHCP) is used to receive and process requests for unique DHCP addresses for IP hosts connected to LAN environments.

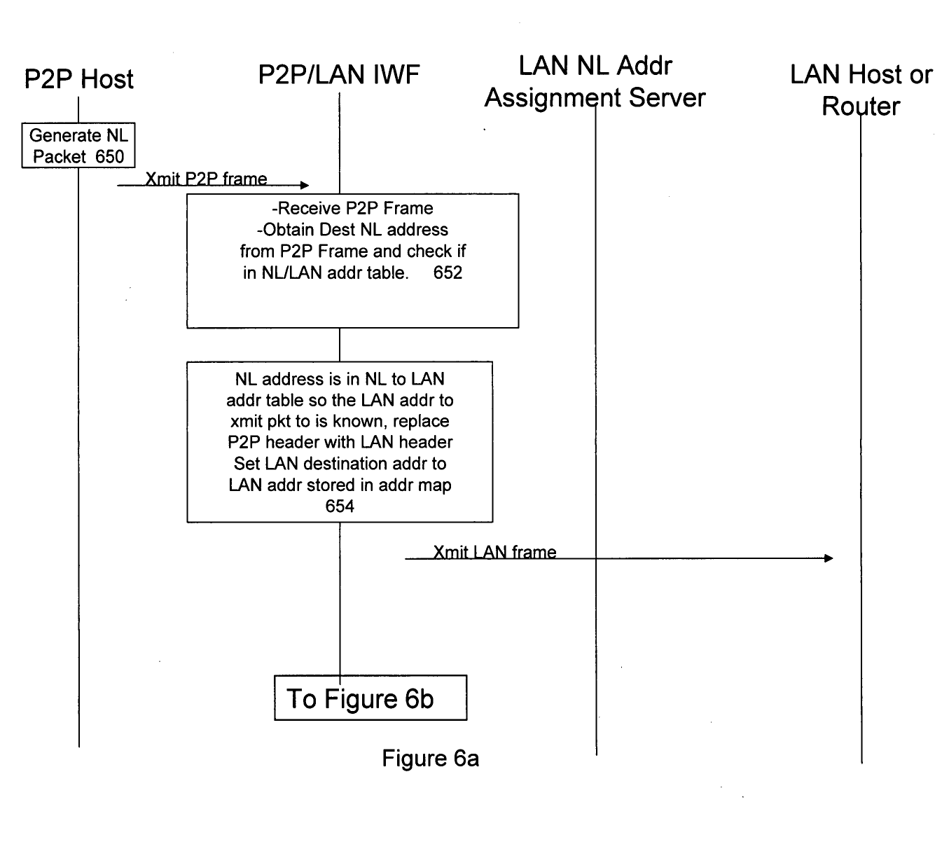

FIGS. 4, 6a through 10 are flow sequences illustrating methods according to exemplary embodiments of the present invention. The techniques illustrated in these figures may be performed sequentially, in parallel or in an order other than that which is described. It should be appreciated that not all of the techniques described are required to be performed, that additional techniques may be added, and that some of the illustrated techniques may be substituted with other techniques.

FIG. 4 illustrates a flow sequence of the operations carried out by a control module (such as control module 254 of FIG. 2) in connection with establishing a physical link between a P2P host (such as P2P host 118 of FIG. 1) and an interworking device (such as interworking device 116 of FIG. 1), as well as the allocation of an NL address to be used in connection with client traffic sent/received to/from the P2P host, in accordance with an exemplary embodiment of the present invention. The flow sequence is organized into four columns for operations carried out by the P2P host, the interworking device, a LAN/NL Address Assignment server (such as the LAN/NL Address Assignment server 132 of FIG. 1) and a LAN host (such as the LAN host 130 of FIG. 1). Beginning at 402, the P2P host establishes a link (such as link 120 of FIG. 1) with the interworking device. At 404, the interworking device stores a unique identifier for the physical port to which the link is joined to the interworking device. The unique physical port ID is saved in a P2P link physical port field (such as the P2P link physical port field 270 of FIG. 2) of an P2P Endpoint Assist table (such as the P2P Endpoint Assist table 264 of FIG. 2). At 404, the control module also allocates a unique LAN address from a LAN Address Pool (such as the LAN Address Pool 248 of FIG. 2) for use by hosts on a LAN service (such as the LAN service 122 of FIG. 1) when contacting the P2P host and records the LAN address in a LAN address field (such as LAN address field 276 of FIG. 2) of the P2P Endpoint assist table in a one-to-one relation with the unique physical port ID saved in the P2P link physical port field.

At 406, the P2P host starts to configure its network layer and requests that an NL address be assigned thereto for use in connection with client traffic. The NL address request is sent by the P2P host (e.g. as an IPCP address request when the client layer is an IP network layer and the P2P protocol is the PPP protocol). At 408, a P2P/NL Address Assignment function (such as the P2P/NL Address Assignment function 282 of FIG. 3) receives the NL address request and, in response thereto, directs a LAN/NL Address Assignment function (such as the LAN/NL Address Assignment function 284 of FIG. 3) to obtain an NL address from the LAN service to be allocated for use by the P2P host. The LAN/NL Address Assignment function in turn transmits a request over the LAN service requesting one or more LAN/NL Address Assignment server to provide an available NL address. At 412, the LAN/NL Address Assignment server responds with an available NL addresses. At 414, the LAN/NL Address Assignment function selects one of the available NL addresses and provides it to the P2P/NL Address Assignment function. Also at 414, the P2P/NL Address Assignment function builds an NL address assignment reply including the selected NL address. The reply is built in accordance with the P2P protocol in use on the link and passed to a P2P frame transceiver (such as the P2P frame transceiver 250 of FIG. 2) to be sent to the P2P host. At 416, the P2P host reviews the NL address offer and approves the address provided by the interworking device and stores the selected NL address for use as the source NL address in connection with subsequent client traffic sent from the P2P host. The approval is communicated back via an acknowledgement to the interworking device, and the Network Layer is considered up, as indicated at 422. At 424, the P2P/NL Address Assignment function informs the LAN/NL Address Assignment function of the acceptance of the NL address by the P2P host. The LAN/NL Address Assignment function informs the LAN/NL Address Assignment server of the selected NL address. At 426, the LAN/NL Address Assignment server removes the selected NL address from the list of available NL addresses. Also at 426, an acknowledgement is sent by the LAN/NL Address Assignment server back to the interworking device along with the LAN/NL prefix mask and the NL address of the Default Router (such as router 126 of FIG. 1). At 428, the LAN/NL Address Assignment function then stores the selected NL address, its prefix mask and the NL address of the Default Router, in the P2P Endpoint Assist table (in fields such as the NL address field 272, the NL SubNet field 274 and the LAN Default Router field 278 of FIG. 2) in a one-to-one relation with the corresponding LAN address stored in the LAN address field and P2P physical port ID stored in the P2P link physical port field. If the response from the LAN/NL Address Assignment server also includes the LAN address of the Default Router, then an entry is created in a NL/LAN Addr table (such as the NL/LAN Addr table 262 of FIG. 2) for the Default Router NL address containing the provided LAN address.

In accordance with the above process, the interworking device provides a control operation for establishing an NL address to be used by a P2P host in connection with a LAN service (such as LAN service 122 of FIG. 1), where the request for the NL address originates utilizing the P2P/NL Address Assignment protocol yet is assigned utilizing the LAN/NL Address Assignment protocol.

By way of example, an IP address (a 32-bit address typically written in the format xxx.xx.xx.xxx) prefix is associated with a LAN service (such as the LAN service 122 of FIG. 1). The prefix may be 101.11.01.0 with a mask length of 24-bits. In this example, any destination IP address that begins with the 24-bit prefix 101.11.01.0 would correspond to a device on the LAN service. A DHCP server, acting as a LAN/NL Address Assignment Server (such as the LAN/NL Address Assignment Server 132 of FIG. 1), would indicate that the mask for the local LAN service was 24-bits in length (from the most significant, or left end of the IP address). Hence, any client traffic with a destination IP address having the IP address prefix 101.11.01 would be directed to a destination device on the LAN service. Any client traffic with a destination IP address differing from the IP address prefix 101.11.01 would not lie on the LAN service. Instead, the client traffic would need to be routed, through a default router (such as router 126 of FIG. 1) to reach other IP subnetworks, including a remote LAN service (such as remote LAN service 124 of FIG. 1).

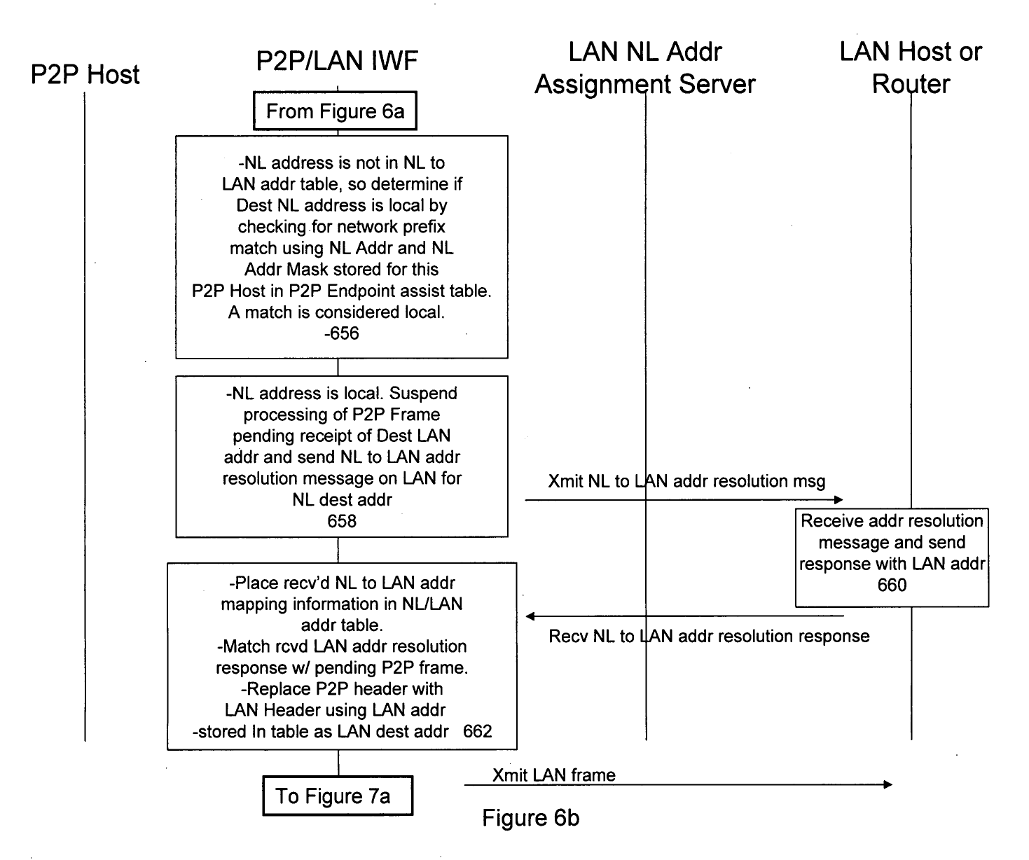

FIG. 5 illustrates a block diagram of a portion of an interworking device (such as interworking device in FIG. 2) utilized to forward data from a P2P environment (such as the P2P environment 112 of FIG. 1) to a LAN environment (such as LAN environment 114 of FIG. 1) (e.g. from P2P host 118 of FIG. 1 to Ethernet host 130 of FIG. 1), namely a data forwarding module 558. The P2P transceiver 550 receives incoming P2P frames and passes the client traffic to the client traffic manager 586. The client traffic manager 586 retains the client traffic for subsequent routing over the LAN environment. The P2P transceiver 550 passes the source and destination IP addresses from the client traffic to a subnet address analysis (SAA) function 588. The SAA function 588 accesses a P2P Endpoint Assist table (such as the P2P Endpoint Assist table 264 of FIG. 2) to obtain the NL subnet information associated with the NL address that has been allocated to the P2P host sending the client traffic. The SAA function 588 compares the destination NL address from the client traffic with the subnet mask and stored NL address to determine whether the destination NL address lies within the local LAN service (such as LAN service 122 of FIG. 1).

An NL/LAN Addr map manager 590 accesses and updates the NL/LAN Addr table 562. An NL/LAN address resolution (NL/LAN AR) Request Function 592 sends requests over a LAN service (such the LAN service 122 of FIG. 1) for a LAN address associated with a particular destination NL address. The NL to LAN AR function 592 receives from the LAN service replies to the NL to LAN addr requests sent and a LAN frame reconstruction function 596 builds LAN frames, each of which contains a LAN header (with LAN address) and the client traffic held by the client traffic manager 586 to be conveyed over the LAN service.

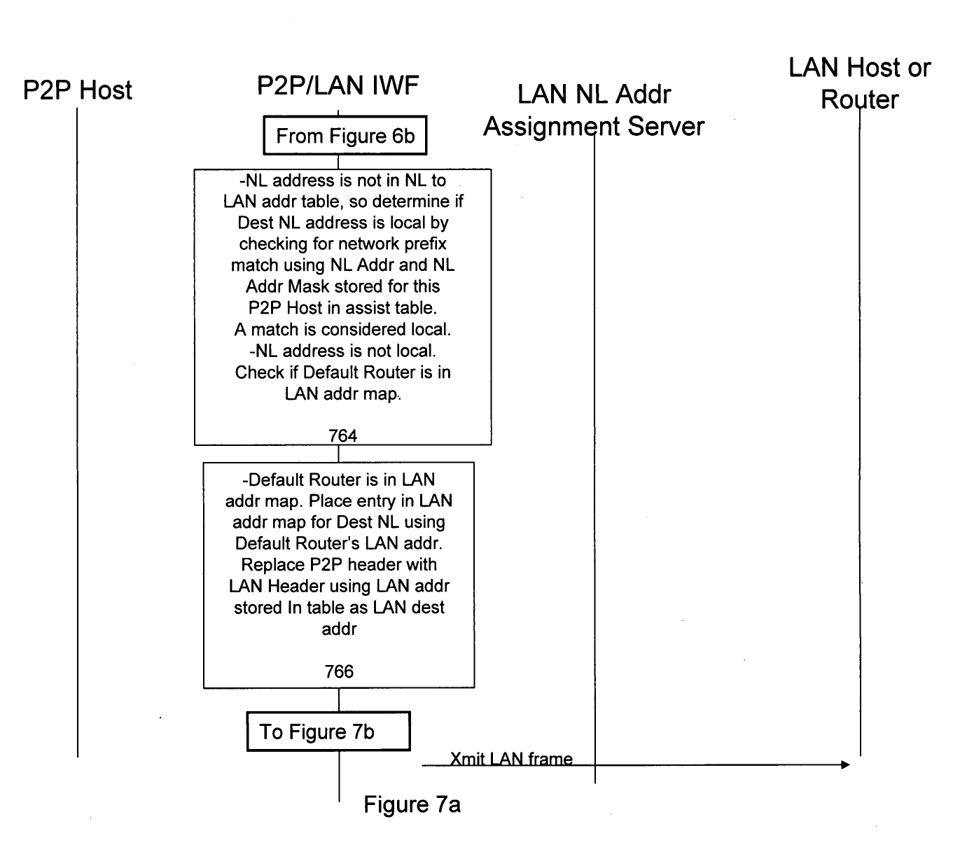

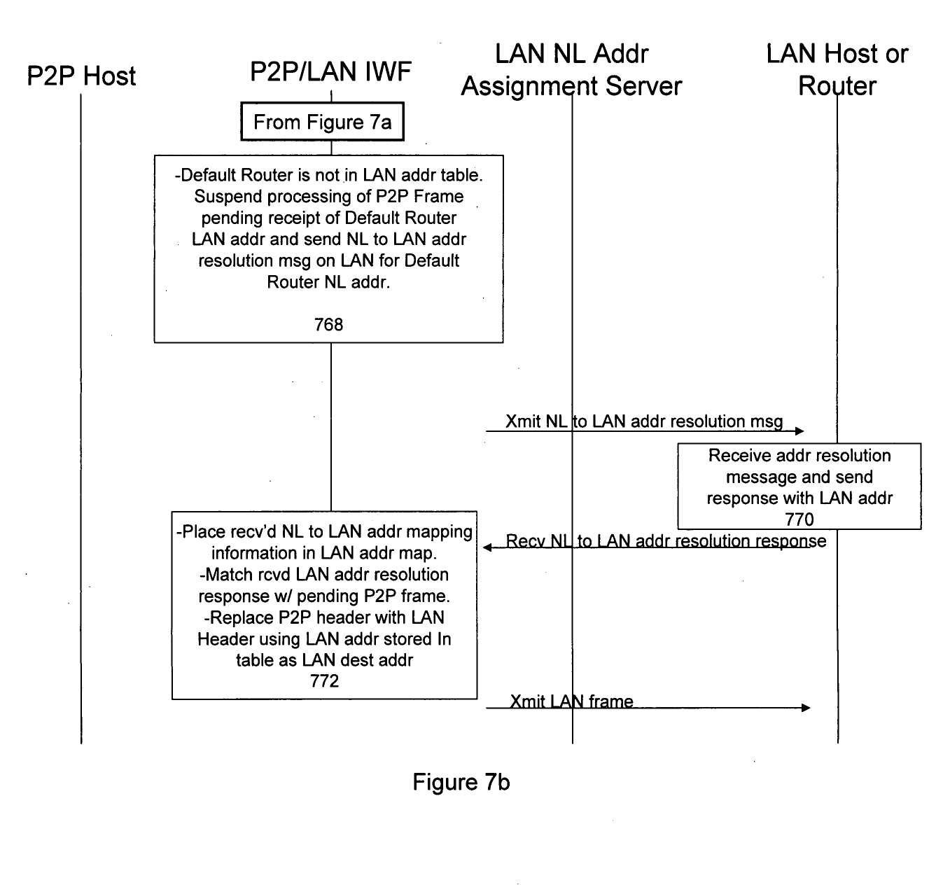

FIGS. 6a, 6b, 7a and 7b illustrates the flow sequence performed by a data forwarding module (such as data forwarding module 558 of FIG. 5) in connection with forwarding client traffic from a P2P environment (such as the P2P environment 112 of FIG. 1) to a local LAN service (such as the LAN service 122 of FIG. 1) in a LAN environment (such as the LAN environment 114 of FIG. 1). FIG. 6a is implemented when a destination NL address is already stored in an NL/LAN address table (such as NL/LAN address table 262 of FIG. 2). FIG. 6b is implemented when a destination NL address is not already stored in an NL/LAN address table and the destination NL address is on the LAN service. FIG. 7a is implemented when a destination NL address is not already stored in an NL/LAN address table, the destination NL address is not on the LAN service and the default router LAN address is known. FIG. 7a is implemented when a destination NL address is not already stored in an NL/LAN address table, the destination NL address is not on the LAN service and the default router LAN address is unknown.

At 650, a P2P host (such as the P2P host 118 of FIG. 1) sends a P2P frame over a link (such as link 120 of FIG. 1). The P2P frame includes the appropriate P2P header and the encapsulated client-layer (e.g. Network Layer) traffic. At 652, a P2P frame transceiver (such as the P2P frame transceiver 550 of FIG. 5) receives the P2P frame, removes the client traffic and provides the client traffic to a client traffic manager (such as the client traffic manager 586 of FIG. 5). The client traffic manager retrieves an entry in a P2P Endpoint Assist Table (such as the P2P Endpoint Assist Table 264 of FIG. 2) for the P2P interface where the P2P frame was received. The client traffic manager retrieves the destination NL address from the client traffic and consults an NL/LAN addr map manager (such as the NL/LAN addr map manager 590 of FIG. 5) to determine if an entry already exists in an NL/LAN Addr table for the destination NL address. If the entry exists in the NL/LAN Addr table, then flow moves in FIG. 6a to 654, where the client traffic manager provides a LAN frame transceiver (such as the LAN frame transceiver 252 of FIG. 2) with LAN address in the P2P Endpoint Assist Table as the source LAN address, the LAN address in the NL/LAN Addr table as the destination LAN address, and the client traffic for transmission.

If an entry does not exist in the NL/LAN Addr table for the destination NL address, flow passes to FIG. 6b. In FIG. 6b, at 656, the client traffic manager provides the NL subnet mask and the NL address from the P2P Endpoint Assist Table along with the destination NL address retrieved from the client traffic to an SAA function (such as the SAA function 588 of FIG. 5) to determine whether the destination NL address is in the local LAN service. The method to determine if the destination NL address is in the local LAN service is dependent on the client-layer (i.e. Network Layer) protocol in use. As an example, for IP client-layer traffic, the destination NL address as well as the NL address assigned to the P2P endpoint are each logically AND'ed with the NL subnet mask. The result is then compared, and if it is the same, the endpoint is in the local LAN service. If the results are not the same, then the endpoint is not in the local LAN service. This result is then returned to the client traffic manager.

When the destination NL address is not in the NL/LAN Addr table and is in the local LAN service, flow moves to 658 in FIG. 6b, where the destination NL address is resolved into a LAN address. The resolution is initiated by the client traffic manager. The client traffic manager provides the LAN address in the P2P Endpoint Assist table, the NL address to be resolved, and the client traffic to an NL/LAN AR Request Function (such as the NL/LAN AR Request Function 592 of FIG. 5). The NL/LAN AR Request Function places the client traffic on its pending traffic queue (such as the pending traffic queue 246 of FIG. 2). The pending traffic queue associates, with the client traffic, the NL address to be resolved and the source LAN address. Once the LAN address has been resolved, the client traffic may then be transmitted. The NL/LAN AR Request Function then transmits an NL to LAN Addr Resolution request over the LAN service.

At 660, the destination device within the LAN environment, having the destination NL address in the request, sends an NL to LAN Addr Resolution response that includes the NL address being resolved, and the corresponding LAN address of the destination device. At 662, the NL/LAN AR Request Function receives this response and requests the NL/LAN addr table manager to create an entry for the NL address and the corresponding LAN address in associated fields (such as fields 268 and 266 in FIG. 2) in the NL/LAN addr table. The NL/LAN Addr Resolution Request Function evaluates, in order, the entries on the pending traffic queue to identify entries that matched the NL address resolved. For each matching entry, the LAN frame transceiver is provided the source LAN address associated with the entry. For each matching entry, the LAN frame transceiver is also provided with the LAN address corresponding to the resolved NL address as the destination LAN address, and the client traffic for transmission.

When the destination NL address is not on the local LAN service, flow moves to 764 in FIG. 7a. At 764, the client traffic manager consults the NL/LAN addr table manager to determine if an entry already exists in the NL/LAN Addr table for the NL Default Router (such as router 126 of FIG. 1) using an NL address stored in a NL Default Router field (such as the NL Default Router field 278 of FIG. 2) of the P2P Endpoint Assist Table. If an entry exists in the NL/LAN addr table, at 666, the client traffic manager will request the NL/LAN Addr table manager to create an entry in the NL/LAN Addr table for the destination NL address. The entry in the NL/LAN Addr table is created using the LAN address of the NL Default Router as the LAN address. The client traffic manager will then provide i) the LAN frame transceiver with LAN address in the P2P Endpoint Assist Table as the source LAN address, ii) the LAN address of the NL Default Router as the destination LAN address, and iii) the client traffic for transmission.

Returning to 764, when the NL address in the NL Default Router field is not in the NL/LAN Addr table, the NL Default Router needs to be resolved into a LAN address.

Flow moves to FIG. 7b where, at 768, the resolution is initiated by the client traffic manager. The client traffic manager provides i) the LAN address in the P2P Endpoint Assist table, ii) the NL address of the NL Default Router to be resolved, and iii) the client traffic to the NL/LAN Addr Resolution Request Function. The NL/LAN Addr Resolution Request Function places the client traffic on its pending traffic queue. The pending traffic queue associates, with the client traffic, the NL address to be resolved and the source LAN address. Once the NL address has been resolved, the client traffic may then be transmitted. The NL/LAN Addr Resolution Request Function then transmits an NL to LAN Addr Resolution request over the LAN service.

At 770, the destination device within the LAN environment, having the destination NL address in the request, sends an NL to LAN Addr Resolution response that includes the NL address being resolved, and the corresponding LAN address of the destination device. At 772, the NL/LAN AR Request Function receives this response and requests the NL/LAN addr map manager to create an entry for the NL address and the corresponding LAN address in associated fields (such as fields 268 and 266 of FIG. 2) in the NL/LAN addr table. The NL/LAN AR Request Function evaluates, in order, the entries on the pending traffic queue to identify entries that matched the NL address resolved. For each matching entry, the LAN frame transceiver is provided the source LAN address associated with the entry. For each matching entry, the LAN frame transceiver is also provided with the LAN address corresponding to the resolved NL address as the destination LAN address, and the client traffic for transmission.

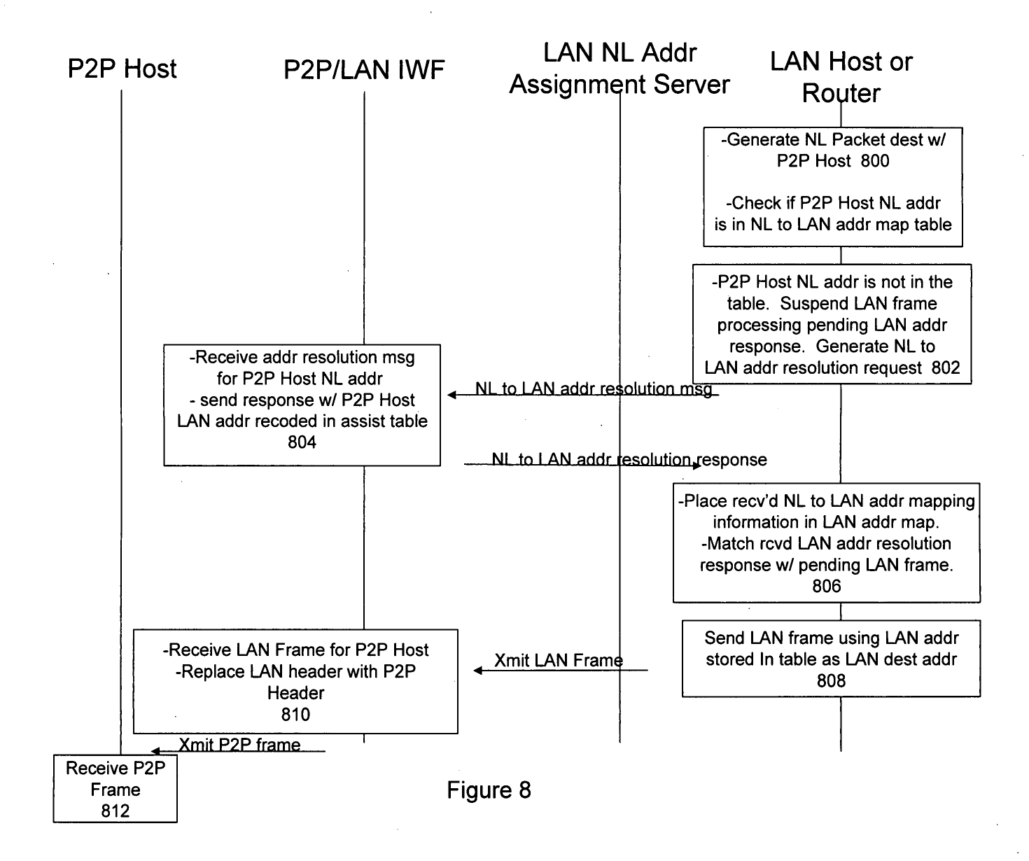

FIG. 8 illustrates a flow sequence performed by a data forwarding module (such as data forwarding module 558 as in FIG. 5) in connection with the conveyance of client traffic from a LAN host (such as LAN host 130 of FIG. 1) to a P2P host (such as P2P host 118 of FIG. 1). At 800, the LAN host or an NL router (such as NL router 126 of FIG. 1) generates an NL packet, the destination of which is the P2P host. In the processing of the packet, a check is made to determine if the NL address of the P2P host is in a NL/LAN addr table stored on the LAN host or LN router. If an entry does not exist, the LAN host or NL router will resolve the NL address of the P2P host into a LAN address. At 802, the LAN host broadcasts an NL to LAN Addr Resolution request message containing a destination NL address. At 804, a NL/LAN Addr Resolution responder (such as NL/LAN Addr Resolution responder 594 of FIG. 5) compares the destination NL address within the NL to LAN Addr Resolution request message with NL addresses stored in a P2P Endpoint Assist table (such as P2P Endpoint Assist table 264 of FIG. 2). When it is determined that the NL to LAN Addr Resolution request corresponds to a P2P host supported by an interworking device (such as interworking device 116), at 804, the NL/LAN Addr Resolution Responder replies with the corresponding LAN address from the P2P Endpoint Assist table that has been reserved for the P2P host associated with the NL address. At 806, the LAN host updates a NL/LAN addr table (such as NL/LAN addr table 262 of FIG. 2). At 808, the LAN host begins sending LAN frames to the P2P host, utilizing a LAN header and the corresponding client traffic. The LAN header includes the LAN address associated with the P2P host. At 810, a LAN frame transceiver (such as LAN frame transceiver 252 of FIG. 2) receives the LAN frames and removes the LAN header, keeping track of the LAN address they were sent to. An entry is retrieved from the P2P Endpoint Assist table that is associated with the LAN address, to which the LAN frames were sent. At 810, the P2P frame transceiver 250 is provided with the P2P Port, and the client traffic. A P2P frame transceiver (such as P2P frame transceiver 250 of FIG. 2) constructs a P2P frame including an appropriate P2P protocol header and the client traffic. The P2P frame is then transmitted at 810 on the specified P2P Port, across a link (such as link 120 of FIG. 1) connected to the P2P host. At 812, the P2P frame is received by the P2P host. In the foregoing manner, client traffic is routed through the interworking device from the LAN host to the P2P host.

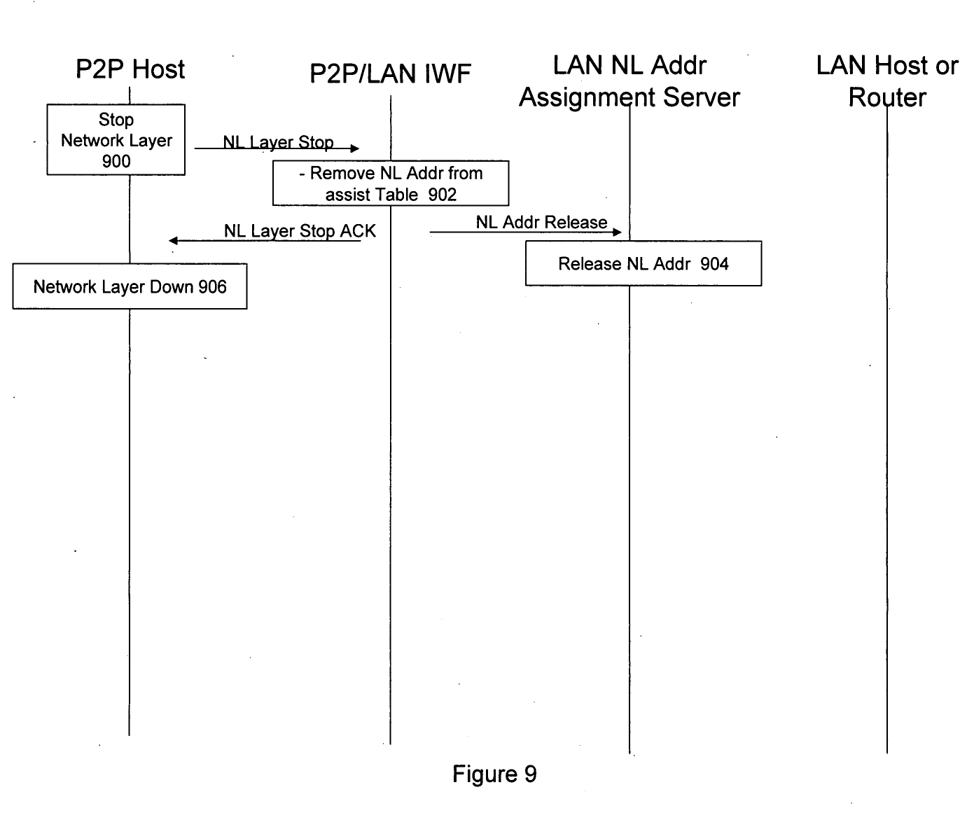

FIG. 9 illustrates a flow sequence carried out to shutdown a network layer in accordance with an exemplary embodiment of the present invention. When a P2P host (such as P2P host 118 of FIG. 1) determines to cease the use of a P2P link (such as P2P link 120 of FIG. 1) for a particular Network Layer, at 900, the P2P host issues a Network Layer Stop message. At 902, a P2P frame transceiver (such as P2P frame transceiver 250 of FIG. 2) receives the Network Layer Stop message, and generates a Network Layer down event. At 802, in response to the Network Layer down event, an interworking device (such as interworking device 116 of FIG. 1) sends a message directing a LAN/NL Address Assignment Server (such as LAN/NL Address Assignment Server 132 of FIG. 1) to release the NL address assigned to the P2P host. Since the NL address is no longer assigned to the P2P host, the values in NL Subnet and LAN Default Router fields of a P2P Endpoint Assist Table (such as fields 274 and 278 of P2P Endpoint Assist Table 264 of FIG. 2) are no longer valid. Therefore, at 902, the values in the NL Subnet field and LAN Default Router field are removed from the P2P Endpoint Assist Table. At 904, the LAN/NL Address Assignment Server receives the NL address release message and places the NL address onto a list of available addresses. At 906, the P2P host receives the Network Layer Stop acknowledgement and places the network layer in a down state.

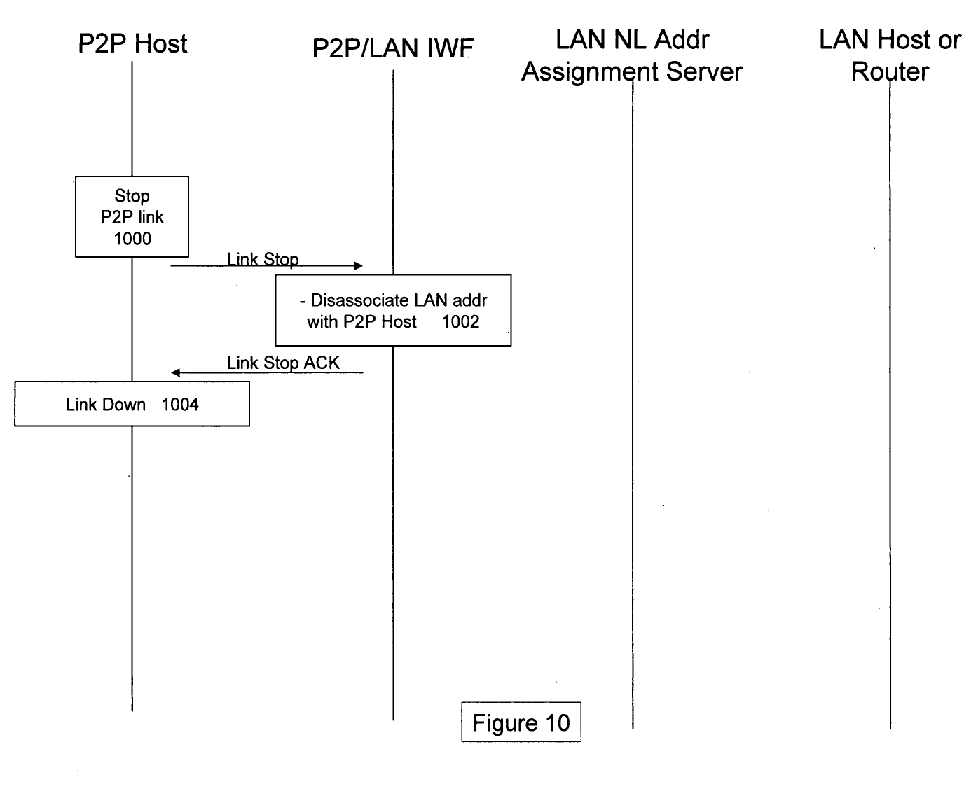

FIG. 10 illustrates a flow sequence carried out to shutdown all communications across a P2P link (such as the P2P link 120 of FIG. 1) in accordance with an exemplary embodiment of the present invention. At 1000, the P2P host (such as the P2P host 118 of FIG. 1) determines to cease the use of the P2P link for P2P communications, and issues a Link Stop message. At 1002, a P2P frame transceiver (such as the P2P frame transceiver 250 of FIG. 2) receives the Link Stop message, and returns the LAN Address that has been associated with the P2P host to be returned to a LAN Addr Pool (such as the LAN Addr Pool 248 of FIG. 2). The P2P frame transceiver sends a Link Stop acknowledgement to the P2P host. At 1004, the P2P host receives the Link Stop acknowledgement and places the link in a down state.

Optionally, the LAN service (such as the LAN service 122 of FIG. 1) may utilize a different layer 2 protocol other than Ethernet. In the present examples, the P2P environment (such as the P2P environment 112 of FIG. 1), LAN environment (such as the LAN environment 122 of FIG. 1) and interworking device (such as the interworking device 116 of FIG. 1) utilize IP as the layer 3 protocol, although, optionally, a different layer 3 client-level protocol may be used. In the above example, the client traffic is defined based on the Internet protocol (IP), although optionally other protocols may be used, for example Novell's Internetwork Packet eXchange (IPX), DECnet and the like. Optionally, the P2P link (such as the P2P link 120 of FIG. 1) may represent a DSL link over a phone line, a DS1 link, a DS3 link and the like. Optionally, more than one router (such as the router 126 of FIG. 1) may be provided for connection to different remote LAN services (such as the remote LAN services 124 of FIG. 1). Optionally, the local LAN service (such as the local LAN service 122 of FIG. 1) may be joined to a non-LAN service through another router. Optionally, more than one LAN/NL Address Assignment server (such as the LAN/NL Address Assignment server 132 of FIG. 1) may be utilized.

While the invention has been described in terms of various specific exemplary embodiments, those skilled in the art will recognize that the invention can be practiced with modification and thus changes may be made thereto, in a computer program product or software, hardware or any combination thereof, within the spirit and scope of the claims. The specification and drawings are accordingly to be regarded in an illustrative rather than in a restrictive sense.

Software embodiments of the present invention may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

What is claimed is:

1. An interworking device providing an interface between a point-to-point (P2P) environment and a local access network (LAN) environment, the interworking device comprising:
a P2P transceiver adapted to communicate with a P2P host utilizing P2P frames formatted in accordance with a P2P protocol, wherein the P2P frames include client traffic having client level network layer (NL) information associated with a common predefined client level network layer protocol; and
a data forwarding module adapted to utilize the NL information to map the client traffic from the P2P frames into LAN frames.

2. The device of claim 1, wherein the NL information includes at least one destination NL address.

3. The device of claim 1, wherein the P2P and LAN frames include at least one of network layer address assignment information, fault handling information, P2P node identification information, local LAN traffic destination information and remote LAN traffic destination information.

4. The device of claim 1, further comprising a P2P-to-network layer (P2P/NL) Address Assignment function to determine when the P2P frames include P2P NL address requests.

5. The device of claim 1, further comprising a LAN-to-network layer (LAN/NL) Address Assignment function to communicate with a LAN/NL Addr Assignment server on the LAN environment to obtain an IP address to be associated with a P2P host on the P2P environment.

6. The device of claim 1, further comprising memory to store a P2P Endpoint Assist table having a LAN address and NL address associated with a P2P host on the P2P environment, the data forwarding module utilizing the LAN and NL addresses to convey the client traffic to and from the LAN environment.

7. The device of claim 1, further comprising a subnet address analysis function to determine whether an NL address in the client traffic corresponds to a local LAN service.

8. The device of claim 1, further comprising a control module to assign a LAN address to a physical link between the P2P interface and a P2P host in the P2P environment.

9. The device of claim 1, wherein the LAN environment includes a local LAN joined to a router that establishes a link to a remote network, the data forwarding module to forward the P2P frames to the remote network by directing the P2P frames to a LAN address associated with the router linked to the remote network.

10. A method for providing an interface between a point-to-point (P2P) environment and a local area access network (LAN) environment, the method comprising:
transmitting P2P frames, wherein the P2P frames include client traffic having network layer (NL) information associated with a common predefined client level network layer protocol; and
utilizing the NL information to map the client traffic from the P2P frames into LAN frames.

11. The method of claim 10, further comprising obtaining, from a NL LAN Address Assignment server, an NL address to be allocated for the P2P host.

12. The method of claim 10, further comprising receiving a P2P NL address request from the P2P host and, in response thereto, creating a LAN/NL address request.

13. The method of claim 10, receiving, from the LAN environment, an IP address allocated for the P2P host, and building a P2P NL Address reply containing the NL address to be sent to the P2P host over the P2P environment.

14. The method of claim 10, wherein the LAN environment includes a local Ethernet and remote network(s), the method further comprising analyzing the NL information received in the P2P frame based on a NL sub-net mask to determine whether the P2P frame is directed to the local Ethernet or the remote network(s).

15. The method of claim 10, wherein the P2P frame includes an NL frame combined with a P2P header, the NL frame including a destination NL address of a destination device on the LAN environment, the mapping including removing the P2P header and reconstructing the NL frame with a LAN header having a LAN address associated with the destination device on the LAN environment.

16. The method of claim 10, wherein the LAN frame includes an NL frame combined with a LAN header, the NL frame including a destination NL address of the P2P host, the mapping including removing the LAN header and reconstructing the NL frame with a P2P header.

17. The method of claim 10, further comprising receiving an NL to LAN Addr Resolution message including an NL address allocated to the P2P host and, in response thereto, sending over the LAN environment a reply having a LAN address associated with the NL address allocated to the P2P host.

18. The method of claim 10, wherein the P2P frame includes an NL frame having a destination NL address of a destination device on the LAN environment, the method further comprising constructing an NL to LAN Address Resolution request based on the NL frame received from the P2P host and broadcasting the NL to LAN Address Resolution request over the LAN environment requesting the LAN address of the destination device.

19. The method of claim 10, wherein the P2P frame includes an NL frame having a destination NL address of a destination device on a remote network, the method further adding a LAN header to the NL frame where the LAN header includes a LAN address associated with a router on the local Ethernet joined to the remote network.

20. An interworking device providing an interface between a point-to-point (P2P) environment and a local access network (LAN) environment, the interworking device comprising:
a LAN transceiver adapted to communicate, over a LAN environment, with a LAN host utilizing LAN frames formatted in accordance with a LAN protocol, wherein the LAN frames include client traffic having client level network layer (NL) information associated with a common predefined client level network layer protocol; and
a data forwarding module adapted to utilize the NL information to map the client traffic from the LAN frames into P2P frames.

21. The device of claim 20, wherein the NL information includes at least one destination NL address.

22. The device of claim 20, wherein the P2P and LAN frames include at least one of automatic network layer address assignment information, fault handling information, P2P node identification information, local LAN traffic destination information and remote LAN traffic destination information.

23. The device of claim 20, further comprising a NL/LAN Addr Resolution Requester function to transmit NL/LAN Addr resolution requests over the LAN environments.

24. The device of claim 20, further comprising a LAN-to-network layer (LAN/NL) Address Assignment function to communicate with a LAN/NL Addr Assignment server on the LAN environment to obtain an NL address to be associated with a P2P host on the P2P environment.

25. The device of claim 20, further comprising memory to store a P2P Endpoint Assist table having a LAN address and NL address associated with a P2P host on the P2P environment, the data forwarding module utilizing the LAN and NL addresses to convey the client traffic to and from the LAN environment.

26. The device of claim 20, further comprising a subnet address analysis function to determine whether an NL address in the client traffic corresponds to a local LAN service.

27. The device of claim 20, wherein the LAN environment includes a local LAN joined to a router that establishes a link to a remote network, the data forwarding module to forward the P2P frames to the remote network by directing the P2P frames to a LAN address associated with the router linked to the remote network.

28. A method for providing an interface between a point-to-point (P2P) environment and a local area access network (LAN) environment, the method comprising:
transmitting LAN frames formatted in accordance with a LAN protocol, wherein the LAN frames include client traffic having network layer (NL) information associated with a common predefined client level network layer protocol; and
utilizing the NL information to map the client traffic from the LAN frames into a P2P environment.

29. The method of claim 28, further comprising obtaining, from a NL LAN Address Assignment server, an NL address to be allocated for the P2P host.

30. The method of claim 28, further comprising receiving an P2P/NL address request from a P2P host and, in response thereto, creating an LAN/NL address resolution request.

31. The method of claim 28, receiving, from the LAN environment, an IP address allocated for a P2P host, and building an P2P NL Address reply containing the NL address to be sent to the P2P host over the P2P environment.

32. The method of claim 28, wherein the LAN environment includes a local Ethernet and remote network(s), the method further comprising analyzing the NL information received in the P2P frame based on a NL sub-net mask to determine whether the P2P frame is directed to the local Ethernet or the remote network(s).

33. The method of claim 28, wherein the P2P frame includes an NL frame combined with a P2P header, the NL frame including a destination NL address of a destination device on the LAN environment, the mapping including removing the P2P header and reconstructing the NL frame with an LAN header having a LAN address associated with the destination device on the LAN environment.

34. The method of claim 28, wherein the LAN frame includes an NL frame combined with an LAN header, the NL frame including a destination NL address of a P2P host, the mapping including removing the LAN header and reconstructing the NL frame with a P2P header.

35. The method of claim 28, further comprising receiving an NL to LAN Addr Resolution message including an NL address allocated to a P2P host and, in response thereto, sending over the LAN environment a reply having a LAN address associated with the NL address allocated to the P2P host.

36. The method of claim 28, wherein the P2P frame includes an NL frame having a destination NL address of a destination device on the LAN environment, the method further comprising constructing an NL to LAN Address Resolution request based on the NL frame received from a P2P host and broadcasting the NL to LAN Address Resolution request over the LAN environment requesting the LAN address of the destination device.

37. The method of claim 28, wherein the P2P frame includes an NL frame having a destination NL address of a destination device on a remote network, the method further adding an LAN header to the NL frame where the LAN header includes a LAN address associated with a router on the local Ethernet joined to the remote network.
